(19) United States
(12) Patent Application Publication
(10) Pub. No.: US 2017/0215074 A1
(43) Pub. Date: Jul. 27, 2017

(54) FIRMWARE INTEGRITY VERIFICATION METHOD PERFORMED IN VIRTUALIZATION SYSTEM

(71) Applicant: ELECTRONICS AND TELECOMMUNICATIONS RESEARCH INSTITUTE, Daejeon (KR)

(72) Inventors: Byeong Cheol CHOI, Daejeon (KR); Jung Chan NA, Daejeon (KR); Seoung Hyeon LEE, Daejeon (KR)

(21) Appl. No.: 15/157,008

(22) Filed: May 17, 2016

(30) Foreign Application Priority Data
Jan. 26, 2016 (KR) 10-2016-0009653

(51) Int. Cl. H04W 12/10; H04L 9/32; G06F 21/57

(52) U.S. Cl. CPC H04W 12/10; G06F 21/57; H04L 9/3263; H04L 9/3242; G06F 2221/034

(57) ABSTRACT

Provided is an integrity verification method performed in a virtualization system. Specifically, the integrity verification method may include receiving a security key for integrity verification from a mobile device, and verifying an integrity of a test target based on integrity verification information on the test target in a virtualization system using the received security key.

### CROSS-REFERENCE TO RELATED APPLICATION

This application claims the priority benefit of Korean Patent Application No. 10-2016-0009653, filed on Jan. 26, 2016, at the Korean Intellectual Property Office, the disclosure of which is incorporated herein by reference.

### BACKGROUND

1. Field of the Invention

Embodiments relate to a firmware integrity verification method performed in a virtualization system, and more particularly, to firmware integrity verification technology in firmware security used in response to firmware hacking attacks on and forgeries of a user terminal.

2. Description of the Related Art

We are moving from the Internet-based information age, into a super-connected age wherein objects are connected as well. Accordingly, technology for providing various services using connected objects is being developed. Internet of things (IoT) is representative technology that allows intercommunication anywhere and anytime by connecting people, devices, spaces, and data through networks. Such network connectivity enables people-to-object data exchange, in addition to object-to-object data exchange. Accordingly, a user may provide various services through information technology (IT) devices, for example, an embedded device, a network equipment, an IoT device, which may be connected as one through a network.

Such technology provides more convenience for the user, but private information of the user related to IoT may be exposed to an outside source. Thus, demands for more secure firmware and software for IT devices have been increasing. There is an integrity verification method that may be used as a security method of firmware and software of an IT device.

Here, the integrity verification method may be a method of performing integrity verification on a single system or multiple systems including an IT device based on significant information, for example, keys and original integrity values. When the integrity verification method is used, an awareness of significant information exposure is required in a process of managing and verifying the significant information.

Thus, an integrity verification method for security of firmware and software of an IT device that prevents exposure of significant information is required.

### SUMMARY

An aspect provides an integrity verification method of verifying an integrity of firmware by designating a test target for firmware integrity verification as a static test target or a dynamic test target.

Another aspect also provides an integrity verification method of managing a private key and a secret key for firmware integrity verification in an additional mobile device. Still another aspect also provides an integrity verification method of adding a function associated with integrity verification in a virtualization system.

According to an aspect, there is provided an integrity verification method performed in a virtualization system, the method including receiving a security key for integrity verification from a mobile device, generating integrity verification information on a test target in the virtualization system using the received security key, and verifying integrity of the test target by analyzing the generated integrity verification information.

The receiving of the security key may include receiving the security key including a private key for generating a signature based on a public key infrastructure (PKI) and a secret key for authenticating a message.

The generating of the integrity verification information may include generating the integrity verification information using a bootloader image and a kernel image indicating the test target in the virtualization system.

The integrity verification information may include signature information based on a PKI, message authentication information for integrity and authentication security, and cyclic redundancy check (CRC) information.

The signature information based on the PKI may indicate a result of encoding a hash function associated with the integrity verification using a private key included in the security key.

The message authentication information may indicate a result associated with message authentication using a secret key included in the security key.

The verifying of the integrity of the test target may include determining whether the test target is a static test target or a dynamic test target by considering an attribute of the test target.

The verifying of the integrity of the test target may include decoding the signature information included in the integrity verification information by applying a public key asymmetric with a private key to the integrity verification information.

The verifying of the integrity of the test target may include verifying the integrity of the test target by comparing the integrity verification information including the decoded signature information to pre-stored integrity verification information.

According to another aspect, there is provided an integrity verification method performed in a virtualization system, the method including receiving a private key for generating a signature based on a public key infrastructure (PKI) and a secret key for authenticating a message from a mobile device, generating integrity verification information on a test target based on the private key and the secret key using a bootloader image and a kernel image indicating the test target in the virtualization system, determining whether the test target is a static test target or a dynamic test target by considering an attribute of the test target, and verifying the integrity of the test target by analyzing integrity verification information based on a result of the determining.

The integrity verification information may include signature information based on a PKI, message authentication information for integrity and authentication security, and cyclic redundancy check (CRC) information.

The signature information based on the PKI may indicate a result of encoding a hash function associated with integrity verification using the private key.

The message authentication information may indicate a result associated with message authentication using the secret key.

The verifying of the integrity of the test target may include decoding signature information included in the integrity verification information by applying a public key asymmetric with the private key.

The verifying of the integrity of the test target may include verifying the integrity of the test target by comparing the integrity verification information including the decoded signature information to pre-stored integrity verification information.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a virtualization system according to an example embodiment;

FIG. 2 illustrates another example of a virtualization system according to an example embodiment; and

FIG. 3 illustrates an example of an integrity verification method performed in a virtualization system according to an example embodiment.

### DETAILED DESCRIPTION

Reference will now be made in detail to embodiments of the present disclosure, examples of which are illustrated in the accompanying drawings, wherein like reference numerals refer to like elements throughout. Embodiments are described below to explain the present disclosure by referring to the figures.

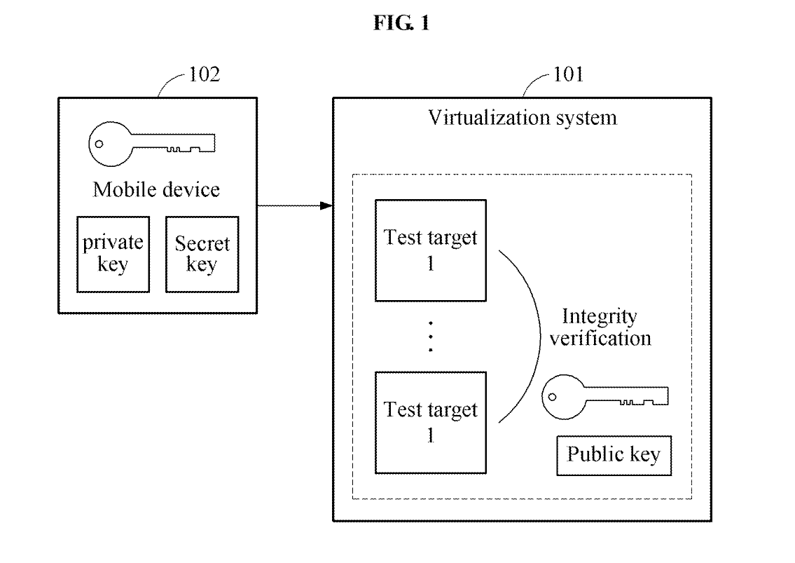

FIG. 1 illustrates an example of a virtualization system according to an example embodiment.

Referring to FIG. 1, a virtualization system 101 may have a function of verifying an integrity of firmware in response to hacking attacks on and forgeries of software and firmware of an information technology (IT) device. Here, the virtualization system 101 may manage a private key and a secret key to enhance integrity verification security of the firmware through an additional mobile device 102. The private key and the secret key are security keys associated with the integrity verification to be adopted in the virtualization system 101 for enhancing safety from an attack from outside. In an example, the private key and the secret key may be managed through a secure universal serial bus (USB) or a trusted platform module (TPM) for safekeeping.

In this example, by using the secure USB, a security key which is significant for the integrity verification may be utilized to apply proposed technology to an existing legacy device and an embedded device to which the TPM is not applied. TPM refers to a module to encode and store significant data in a device.

The private key refers to a key for generating a signature based on a public key infrastructure (PKI). In an example, the private key may refer to a key for generating a signature to provide a digital signature and encoding using a public key algorithm based on the PKI.

The secret key refers to a key for authenticating a message. In an example, the secret key may guarantee integrity and authentication of a test target in the virtualization system 101 based on a hash based message authentication code (HMAC), and the secret key may refer to a key for generating a message authentication code using a hash function. In this example, the integrity indicates that a corresponding message is not changed, and the authentication indicates that the corresponding message is received from an accurate transmitter.

In addition, the virtualization system 101 may receive the private key and the secret key from the mobile device 102. The virtualization system 101 may generate integrity verification information on the test target in the virtualization system 101 using the private key and the secret key received from the mobile device 102. The test target in the virtualization system 101 may indicate a target object for performing verification on the firmware and software based on the virtualization system 101. The test target may be classified as a static test target or a dynamic test target according to types of the firmware and the software.

The virtualization system 101 may designate the test target for the integrity verification as a static test target, for example, a bootloader and a kernel, or a dynamic test target for a predetermined process (available to be included in a memory) of a system. And the virtualization system 101 may generate the integrity verification information on the designated test target.

The virtualization system 101 may verify the integrity of the test target by analyzing the generated integrity verification information. The virtualization system 101 may verify the integrity of the test target by comparing the integrity verification information received from a kernel module to pre-stored integrity verification information in an integrity verification server module.

Here, the virtualization system 101 proposed in the present disclosure may extend a range of the test target for the integrity of the firmware and the software of the IT device by designating the static test target and the dynamic test target with respect to the integrity verification according to types of the firmware and the software. The virtualization system 101 may enhance the security against the hacking attacks on and forgeries of the firmware and the software by additionally adding a function of performing the integrity verification.

In addition, the virtualization system 101 may generate the integrity verification information on the test target using the private key and the secret key received from the mobile device 102, and may prevent significant information from being leaked externally while the integrity verification of the firmware is performed.

Hereinafter, detailed descriptions of verifying the integrity of the test target using each module included in a virtualization system will be provided.

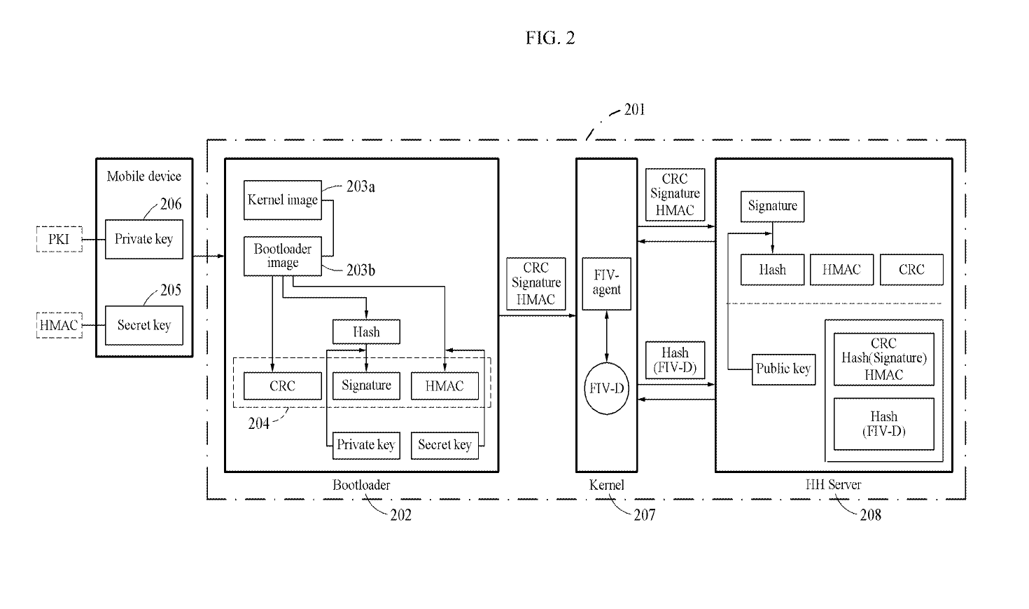

FIG. 2 illustrates another example of a virtualization system according to an example embodiment.

Referring to FIG. 2, a virtualization system 201 may perform integrity verification on a test target based on a private key and a secret key received from a mobile device. For this, the virtualization system 201 may include a bootloader module 202, a kernel module 207, and an integrity verification server module 208, for example, an HH server. As a separate configuration of each module, the virtualization system 201 may be interconnected with the mobile device to perform the integrity verification.

The bootloader module 202 may generate integrity verification information 204 on the test target. In detail, the bootloader module 202 may receive a private key 206 and a secret key 205 from the mobile device. In an example, the mobile device may be a storage medium to store a private key for generating a signature based on a public key infrastructure (PKI) and a secret key for a keyed-hash message authentication code (HMAC). The private key 206 may include information for generating a signature based on the PKI, and the secret key 205 may include message authentication information based on the HMAC.

The bootloader module 202 may generate the integrity verification information 204 on the test target in the virtualization system 201 using the private key 206 and the secret key 205 received from the mobile device. The bootloader module 202 may generate integrity verification info′ cation 204 using a kernel image 203a and a bootloader image 203b indicating the test target in the virtualization system 201. In an example, the bootloader module 202 may include a module to generate a cyclic redundancy check (CRC) value, a signature value, and an HMAC value to generate the integrity verification information 204 through the included module.

The integrity verification information 204 may include signature information based on the PKI, message authentication information for integrity and authentication security, and cyclic redundancy check (CRC) information.

\textcircled{1} The signature information based on the PKI may indicate a result of encoding a hash function according to the kernel image 203a and the bootloader image 203b using the private key 206 received from the mobile device.

\textcircled{2} The message authentication information for the integrity and the authentication security may indicate a result associated with message authentication using the secret key 205 received from the mobile device. In an example, the message authentication information may be an HMAC using a unidirectional hash function. Thus, the message authentication information may indicate a result that guarantees the integrity and the authentication of the test target in the virtualization system 201.

\textcircled{3} The CRC information may indicate a result of determining whether the kernel image 203a and the bootloader image 203b are damaged when compression and transmission are performed on the kernel image 203a and the bootloader image 203b based on a CRC.

The bootloader module 202 may transmit, to the kernel module 207, the integrity verification information 204 on the test target generated using the private key 206 and the secret key 205. Concisely, the bootloader module 202 may transmit, to the kernel module 207, the signature information, the message authentication information, and CRC information included in the integrity verification information 204.

The kernel module 207 may perform the integrity verification based on a state of the test target. Specifically, the kernel module 207 may transmit the integrity verification information 204 received from the bootloader module 202 to the integrity verification server module 208 to perform the integrity verification based on the state of the test target. Here, the state of the test target is a state of a test target for performing the integrity verification, and the state of the test target may be classified as a static test target or a dynamic test target.

The static test target may indicate a target on which the integrity verification is performed in a booting process, and the dynamic test target may indicate a target on which the integrity verification is performed in a system management/operation process.

The kernel module 207 may generate verification information on the test target by considering the state of the test target, that is, whether the integrity verification is to be performed in the booting process or the system management/operation process. Here, the verification information may be information indicating whether the integrity verification is to be performed on the static test target or the dynamic test target.

Thus, the kernel module 207 may include a function of verifying the integrity of the dynamic test target with respect to a predetermined process to be hacked in a file system and a function of verifying the integrity of the static test target according to an attack occurring in the booting process.

Subsequently, the kernel module 207 may transmit the integrity verification information 204 based on the determined verification information to the integrity verification server module 208. In an example, the kernel module 207 may transmit the CRC value, the signature value, and the HMAC value to the integrity verification server module 208.

The integrity verification server module 208 may perform authentication based on the integrity verification of the test target. Here, the integrity verification server module 208 indicates a hosted hypervisor structure. The integrity verification server module 208 may be a module for installing an operating system (OS) to drive a system, and installing a program for virtualization in the OS. The integrity verification server module 208 may perform the authentication according to the integrity verification on firmware and using the hosted hypervisor structure. Here, the integrity verification server module 208 may perform the authentication according to the integrity verification on the firmware and the software of a more extended concept by determining whether the test target is the static test target or the dynamic test target based on an attribute of the test target.

In other words, the integrity verification server module 208 may set whether the test target is the static test target or the dynamic test target based on the integrity verification information 204 received from the kernel module 207. The integrity verification server module 208 may decode the signature information included in integrity verification information 204 received from the kernel module 207 by applying the public key asymmetric with the private key 206 to the integrity verification information 204.

The private key 206 is an encoded key based on the PKI, the integrity verification server module 208 may decode the signature information using the public key asymmetric with the private key 206. The integrity verification server module 208 may verify the integrity of the test target based on the integrity verification information 204 including the decoded signature information.

In an example, the integrity verification server module 208 may verify the integrity of the test target using a module to analyze and compare the CRC value, the signature value, and the HMAC value received from the kernel module 207 to original values, for example, a pre-stored CRC value, a pre-stored signature value, and a pre-stored HMAC value.

The integrity verification server module 208 may verify the integrity of the test target by comparing the integrity verification information 204 received from the kernel module 207 to pre-stored integrity verification information 204 in the integrity verification server module 208.

The kernel module 207 may generate information on the static and dynamic integrity and the integrity verification server module (HH server) 208 may perform an actual role in a process of verifying the static and dynamic integrity. In other words, the integrity verification server module 208 may perform the authentication based on an original database (DB) and the integrity verification.

Subsequently, the integrity verification server module 208 may transmit an authentication result based on the integrity verification of the test target to the kernel module 207.

The kernel module 207 may receive the authentication result based on the integrity verification from the integrity verification server module 208, and process the received authentication result. In an example, the kernel module 207 may use a FIV-agent module to receive and process the authentication result based on the integrity verification from the integrity verification server module 208. Here, the FIV-agent module may be activated in response to a time at which the integrity verification information 204 is received from the bootloader module 202, and may perform an operation associated with the integrity verification by interconnecting with the integrity verification server module 208.

Also, the FIV-agent module may receive the authentication result based on the integrity verification from the integrity verification server module 208, and output an alarm message to a system manager based on the received authentication result. Here, when the authentication result received from the integrity verification server module 208 indicates that the integrity verification is complete, the FIV-agent module may output the alarm message indicating that the integrity verification of the test target performing the integrity verification is complete. Conversely, when the authentication result received from the integrity verification server module 208 indicates that the integrity verification is not complete, the FIV-agent module may output the alarm message to induce a corresponding manager to retest the test target in response to the integrity verification of the test target being not complete.

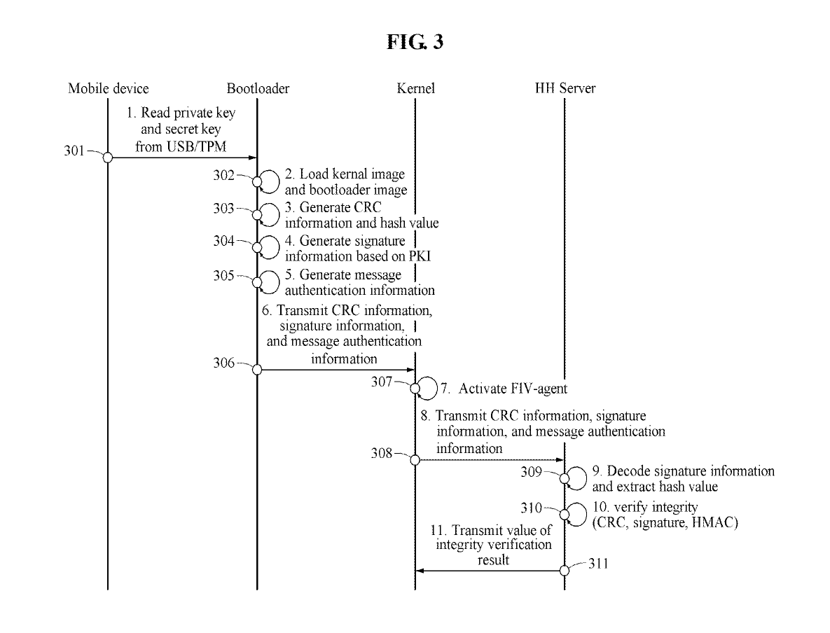

FIG. 3 illustrates an example of an integrity verification method performed in a virtualization system according to an example embodiment.

In operation 301, a mobile device may be interconnected with a virtualization system. A bootloader module included in the virtualization system may receive a key from the connected mobile device. In an example, the mobile device and the virtualization system may be connected, and the virtualization system may read a secret key and a private key from a secure universal serial bus (USB) and a trusted platform module (TPM).

In operation 302, the bootloader module included in the virtualization system may load a kernal image and a bootloader image indicating a test target in the virtualization system. In an example, the bootloader module may be operated before an operating system (OS) starts and may perform an initial operation for performing an appropriate operation for software. The bootloader module may load the kernel image and the bootloader image for performing the initial operation.

In operation 303, the bootloader module included in the virtualization system may generate cyclic redundancy check (CRC) information and a hash value using the loaded kernel image and the bootloader image.

In operation 304, the bootloader module included in the virtualization system may generate signature information based on a public key infrastructure (PKI) using the private key received from the mobile device. Here, the bootloader module may generate the signature information based on the PKI by encoding the hash value generated in operation 303 as the private key.

In operation 305, the bootloader module included in the virtualization system may generate message authentication information for integrity and authentication security using the private key received from the mobile device.

In operation 306, the bootloader module included in the virtualization system may transmit, to a kernel module, integrity verification information including the CRC information, the signature information, and the message authentication information.

In operation 307, the bootloader module included in the virtualization system may receive the integrity verification information from the bootloader module. The kernel module may activate an FIV-agent that receives and processes an authentication result based on integrity verification in response to a time at which the integrity verification information is received.

In operation 308, the bootloader module included in the virtualization system may transmit the integrity verification information including the CRC information, the signature information, and the message authentication information received from the bootloader module to an integrity verification server module, for example, an HH module.

In operation 309, the bootloader module included in the virtualization system may decode the signature information included in the integrity verification information received from the kernel module by applying a public key asymmetric with the private key to the integrity verification information. Concisely, the integrity verification server module may extract the hash value venerated in the bootloader module by decoding the signature information as the public key.

In operation 310, the bootloader module included in the virtualization system may verify an integrity of the test target based on the integrity verification information including the decoded signature information. Concisely, the integrity verification server module may perform authentication based on the integrity verification of the test target by analyzing and comparing a CRC value, a signature value, and an HMAC value received from the kernel module to a pre-stored CRC value, a pre-stored signature value, and a pre-stored HMAC value. Here, the pre-stored CRC value, the pre-stored signature value, and the pre-stored HMAC value may indicate values extracted when an image is created in the integrity verification server module.

In operation 311, the bootloader module included in the virtualization system may transmit a value of an integrity verification result to the kernel module.

Thus, the kernel module and the integrity verification server module included in the virtualization system proposed in the present disclosure may be related to static and dynamic integrity verification. Verification information for differentiating a state of a static test target or a dynamic test target may be generated in the kernel module, and the actual integrity verification of the static test target or the dynamic test target may be performed in the integrity verification server module.

According to example embodiments, an integrity verification method may extend a range of a test target by designating the test target for verifying integrity of a firmware as a static test target or a dynamic test target.

According to example embodiments, an integrity verification method may enhance safety from an attack from outside by managing a private key and a secret key for verifying integrity of a firmware in an additional mobile device.

According to example embodiments, an integrity verification method may provide security and expandability for a virtualization system by adding a function associated with integrity verification to the virtualization system.

The above-described embodiments of the present disclosure may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present disclosure, or vice versa.

Although a few embodiments of the present disclosure have been shown and described, the present disclosure is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An integrity verification method performed in a virtualization system, the method comprising:
receiving a security key for integrity verification from a mobile device;
generating integrity verification information on a test target in the virtualization system using the received security key; and
verifying integrity of the test target by analyzing the generated integrity verification information.

2. The method of claim 1, wherein the receiving of the security key comprises receiving the security key comprising a private key for generating a signature based on a public key infrastructure (PKI) and a secret key for authenticating a message.

3. The method of claim 1, wherein the generating of the integrity verification information comprises generating the integrity verification information using a bootloader image and a kernel image indicating the test target in the virtualization system.

4. The method of claim 1, wherein the integrity verification information comprises signature information based on a PKI, message authentication information for integrity and authentication security, and cyclic redundancy check (CRC) information.

5. The method of claim 4, wherein the signature information based on the PKI indicates a result of encoding a hash function associated with the integrity verification using a private key comprised in the security key.

6. The method of claim 4, wherein the message authentication information indicates a result associated with message authentication using a secret key comprised in the security key.

7. The method of claim 1, wherein the verifying of the integrity of the test target comprises determining whether the test target is a static test target or a dynamic test target by considering an attribute of the test target.

8. The method of claim 4, wherein the verifying of the integrity of the test target comprises decoding the signature information comprised in the integrity verification information by applying a public key asymmetric with a private key to the integrity verification information.

9. The method of claim 8, wherein the verifying of the integrity of the test target comprises verifying the integrity of the test target by comparing the integrity verification information comprising the decoded signature information to pre-stored integrity verification information.

10. An integrity verification method performed in a virtualization system, the method comprising:
receiving a private key for generating a signature based on a public key infrastructure (PKI) and a secret key for authenticating a message from a mobile device;
generating integrity verification information on a test target based on the private key and the secret key using a bootloader image and a kernel image indicating the test target in the virtualization system;
determining whether the test target is a static test target or a dynamic test target by considering an attribute of the test target; and
verifying the integrity of the test target by analyzing integrity verification information based on a result of the determining.

11. The method of claim 10, wherein the integrity verification info′ cation comprises signature information based on a PKI, message authentication information for integrity and authentication security, and cyclic redundancy check (CRC) information.

12. The method of claim 11, wherein the signature information based on the PKI indicates a result of encoding a hash function associated with integrity verification using the private key.

13. The method of claim 11, wherein the message authentication information indicates a result associated with message authentication using the secret key.

14. The method of claim 11, wherein the verifying of the integrity of the test target comprises decoding signature information comprised in the integrity verification information by applying a public key asymmetric with the private key.

15. The method of claim 14, wherein the verifying of the integrity of the test target comprises verifying the integrity of the test target by comparing the integrity verification information comprising the decoded signature information to pre-stored integrity verification information.
